(19) United States
(12) Patent Application Publication
(10) Pub. No.: US 2016/0067884 A1
(43) Pub. Date: Mar. 10, 2016

(54) Crack free dental pressing ring system

(71) Applicant: Il Koo Kim, Old Bridge, NJ (US)

(72) Inventor: Il Koo Kim, Old Bridge, NJ (US)

(21) Appl. No.: 14/121,461

(22) Filed: Sep. 9, 2014

(51) Int. Cl. B28B 7/00

(52) U.S. Cl. CPC B28B 7/0002

(57) ABSTRACT

A metal ring for protecting dental pressing investment ring which frictionally engages the surface of the investment ring, using a thin liner between the investment ring and protective metal ring to absorb the investment ring's expansion during the wax pattern burnout. The metal ring and liner prevents the investment ring from cracking during the pressing of the molten ceramic material.

### BACKGROUND OF THE INVENTION

The present invention relates generally to a device for protecting dental investment ring, more particularly, to new and useful metal ring which cover outside of investment ring for preventing cracking of investment ring during conventional heat pressing techniques.

In dental practice, the lost wax technique is used to create a pressed ceramic crown from a wax pattern. The wax pattern is a replica of a tooth shape or substructure of crown. After the wax pattern is made, it is attached to a sprue for investment. Next, the sprue is attached to a sprue former in a base to hold the wax pattern in place. Then the sprue former is placed to investment mold. The investment material is then poured into investment mold.

After investment ring hardens around the wax patterns, it is removed from the mold and the investment ring is placed into a burnout oven to melt the wax patterns. The molten ceramic material is then filled into the space of the investment ring in the pressing oven.

The investment ring breakage is prone to happen during the pressing process if a user does not follow the manufacturers directions. For that reason, the number and size of wax patterns are limited at dental pressing system. Recently, the wax pattern is being changed to PMMA (poly methyl methacrylate) material which fabricated by CAD/CAM (computer aided design/computer aided manufacturing) system. The PMMA material is more accurate and is suitable for mass production.

However, the PMMA material is very hard to control in the dental pressing system; because the PMMA material expense a lot during the burnout procedure. The expansion causes initial crack of the investment ring. Therefore, after the PMMA material is milled, the surface is covered by hand wax in order to compensate for the PMMA expansion in the burnout oven. Accordingly, there remains a need for improvements to dental investment ring system that enables the system to fully use multiple wax patterns and the PMMA material in the dental pressing system.

### BRIEF SUMMARY OF THE INVENTION

The primary object of the present invention is to provide a crack free dental investment ring that overcomes the disadvantage of the prior art. Another object of the invention is to provide an improved working process and to reduce processing times so that simplifies an otherwise restricted and limited process. A further object of the present invention is to enable newly developed dental materials for full use in dental pressing and casting system.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Crack Free Dental Pressing Ring System comprising:

The present invention is inserted to the dental pressing investment ring with a liner. It protects the investment ring by covering the ring surface. Further in accordance with invention, the dental pressing investment ring can be prevented from any breakage.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1. is a perspective view of device of the invention that applies to the conventional dental pressing investment ring.

FIG. 2. is a perspective view of the device that is applied to the dental pressing investment ring.

FIG. 3. is a schematic plane view of device of the invention that shows protective function.

FIG. 4. is an enlarged schematic view of #4 in FIG. 3.

FIG. 5. is plane view of the second embodiment of the invention that is adapted to the trapezoidal investment ring.

FIG. 6. is a perspective view of the third embodiment of the invention that applies to the dental pressing investment ring.

FIG. 7. is a plane view of the third embodiment of the invention that is adapted to the dental pressing investment ring.

FIG. 8. is a enlarged schematic view of #14 in FIG. 7.

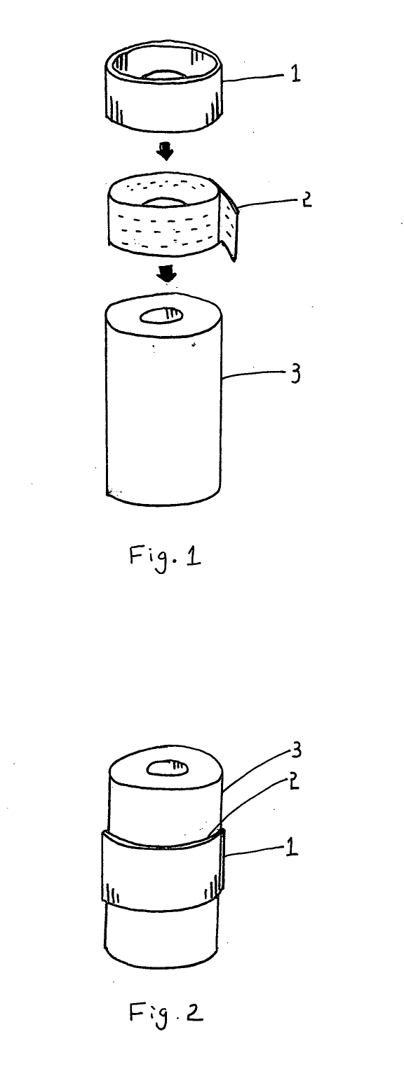

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

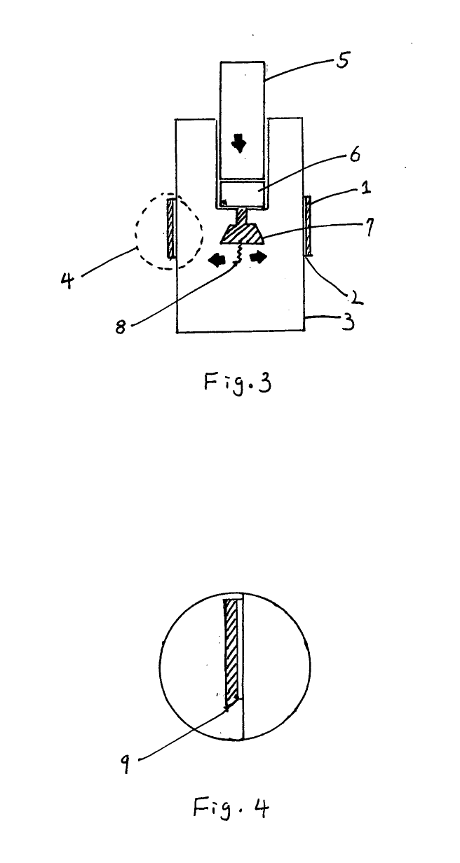

Upon inspection of FIG. 1, it will be seen that the preferred embodiment comprises with liner 2 and metal ring 1 to the surface of investment ring 3. Before metal ring 1's insertion, the linear 2 encircles using regular glue or dental wax. The ideal liner thickness is 1/32″ and non burning fiber dental liner is used. The position of liner and metal ring is the middle portion of the investment ring where wax patterns are invested inside as illustrated in FIG. 3. The inner beveled round edges 9 in FIG. 4 expedites the metal ring insertion and the metal ring frictionally encloses the investment ring. Ideal metal ring thickness is 2 mm with a 2 cm height. The metal ring is slightly larger than the investment ring circumference for the liner space. The investment ring crack and protective function of the invention may be understood upon reference to FIG. 3. Initial crack 8 occurs at the time of burnout wax pattern 7. The crack 8 then gets bigger when plunger 5 pushes down the molten ceramic material 6 into the space where the initial crack occurred. The longer pressing time causes a larger crack and breaks the investment ring almost into two pieces. The metal ring 1 encloses around the investment ring 3 where most cracking occurs , and the liner 2 absorbs ring expansion that is caused from wax pattern burnout, and the metal ring 1 and liner 2 later prevents the investment ring from cracking when the plunger 5 pushes down the molten ceramic 6 into empty space. The arrows in FIG. 3 show the transition of pressing impact to the investment ring.

In accordance with the present invention, FIG. 5 illustrates a second embodiment of the present invention; in this embodiment, the metal ring 11 can be made into a trapezoidal shape to adapt to the trapezoidal investment ring 10. In this shape, the metal ring 11 can be compatible with conventional casting investment ring systems, because the trapezoidal ring shape fits to most conventional casting investment rings.

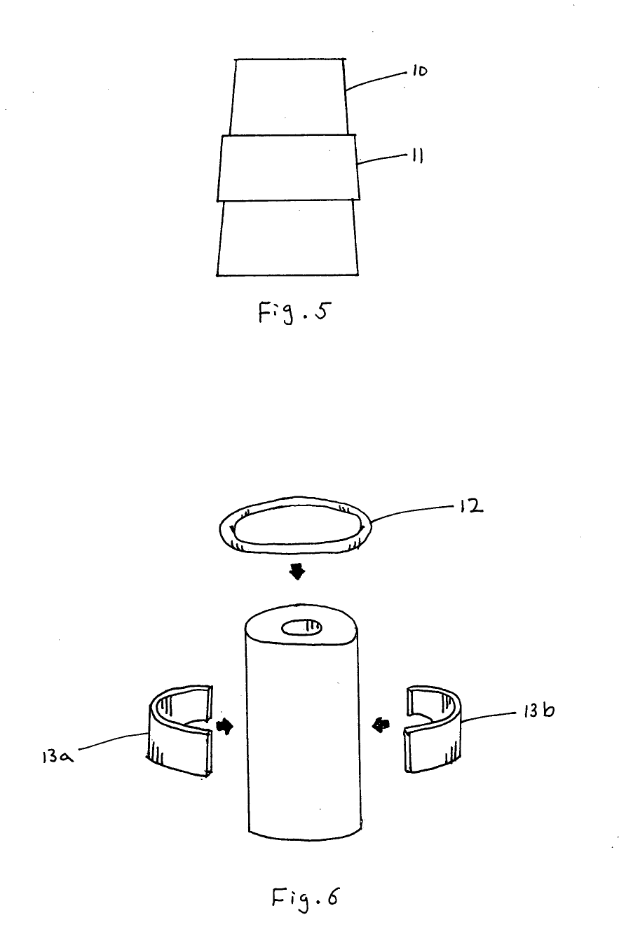

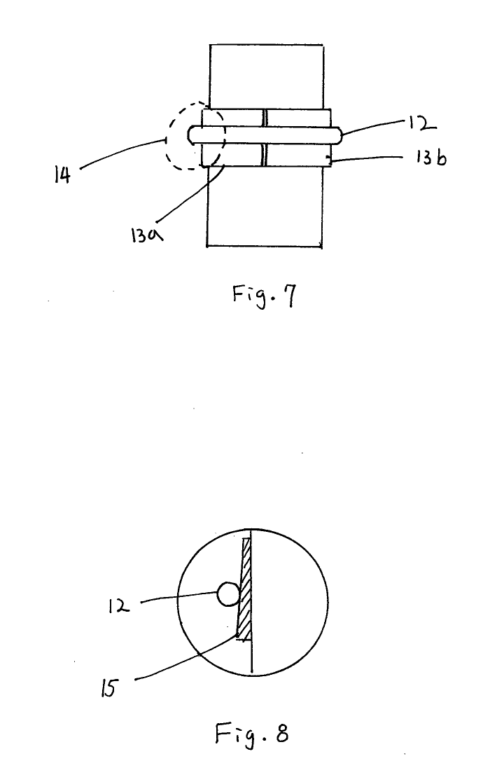

FIG. 6 illustrates a third. embodiment of the. present invention. In this embodiment, the metal ring 13 is split into two semicircular rings 13a and 13b. First, the two metal rings 13a and 13b enclose the investment ring, and then metal O-ring 12 inserts outside. The two metal rings have outer beveled surfaces as illustrated in FIG. 8. The sloped surface 15 of metal rings frictionally engages the O-ring in position.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Crack Free Dental Pressing Ring System comprising:
a liner, said liner encircles between said investment ring surface and said metal ring;
a metal ring, said metal ring frictionally engages over the liner configuring to
an inner beveled round edges at both sides.

2. The metal ring of claim 1, wherein said liner comprises non burning 1/32″ thick said fiber liner.

3. The metal ring of claim 1, wherein said metal ring configures to a 2 mm thickness and a 2 cm width.

4. The metal ring of claim 1, wherein said metal ring further comprises a trapezoidal shape.

5. The metal ring of claim 1, wherein said metal ring further comprises two separated pieces semicircular rings with an O-ring fixed outside.

6. The metal ring of claim 5, wherein said two semicircular rings configures to the outer beveled surface shape.
